(19) United States
(12) Patent Application Publication
(10) Pub. No.: US 2026/0358633 A1
(43) Pub. Date: Nov. 12, 2026

(54) LIGHTGUIDE-INTEGRATED IMAGE PROJECTORS FOR DISPLAYS

(71) Applicant: Lumus Ltd., Ness Ziona (IL)

(72) Inventor: Yochay DANZIGER, Kfar Vradim (IL)

(21) Appl. No.: 19/129,823

(22) PCT Filed: Sep. 28, 2023
(86) PCT No.: PCT/IL2023/051043

§ 371 Date: May 14, 2025

Related U.S. Application Data
(60) Provisional application No. 63/428,739, filed on Nov. 30, 2022.
(60) Provisional application No. 63/435,637, filed on Dec. 28, 2022.
(60) Provisional application No. 63/443,975, filed on Feb. 7, 2023.
(60) Provisional application No. 63/448,666, filed on Feb. 27, 2023.

(51) Int. Cl. G02B 27/01; G02B 27/28

(52) U.S. Cl. CPC G02B 27/0172; G02B 27/283

(57) ABSTRACT

An image projector integrated with a lightguide (10) has a reflective or reflective-refractive (catadioptric) lens (150) deployed on a surface (11) of the lightguide itself, or on a prism surface which is parallel to, or coplanar with, a surface of the lightguide (10). In some cases, a polarizing beam splitter (158) deflects light reflected from the collimating lens so as to directly couple collimated image light into the lightguide (10) so as to propagate within the lightguide. In some cases, the collimating lens (150) is associated with the surface of the lightguide or the prism via an internal-reflection-maintaining interface (154) so that at least part of the image light coupled in to the lightguide is reflected at the internal-reflection-maintaining interface.

### FIELD AND BACKGROUND OF THE INVENTION

The present invention relates to near-eye displays and, in particular, it concerns lightguide-integrated image projectors for injecting images into a lightguide of an augmented reality display.

Near-eye augmented reality displays typically employ an image projector to inject a collimated image into a lightguide which conveys the image to the user's eyes while allowing simultaneously a view of the real world through the lightguide. The image is coupled-out from the lightguide towards the user's eye by a coupling-out arrangement, which may be a set of partially-reflecting obliquely-angled internal surfaces within the lightguide, or a diffractive optical element.

In order to provide a uniform image, it is typically preferable that the injected image should fill the thickness of the lightguide. This requirement, together with the angular field of view (FOV) of the image and the distance of the collimating optics from the lightguide entrance aperture, dictate the minimum size of the collimating optics which is required for collimating the image prior to injection into the lightguide.

### SUMMARY OF THE INVENTION

The present invention is a lightguide-integrated image projector for injecting images into a lightguide of an augmented reality display.

According to the teachings of an embodiment of the present invention there is provided, a display comprising: (a) a lightguide formed from transparent material having a first pair of mutually-parallel major surfaces for supporting propagation of image light by internal reflection at the first pair of major surfaces; (b) an image generator for generating an image at an image plane; (c) a collimating optical arrangement including a reflective lens and an associated quarter-wave phase plate; and (d) a polarizing beam splitter (PBS), wherein the reflective lens is associated with one of the first pair of major surfaces, or with a surface of a prism parallel to or coplanar with one of the first pair of major surfaces, via an internal-reflection-maintaining interface, and wherein the PBS is deployed so that image light from the image plane passes through the PBS to impinge on the reflective lens, is collimated by the reflective lens, and reflected by the PBS so as to be coupled in to propagate within the lightguide by internal reflection at the first pair of major surfaces, at least part of the image light being reflected at the internal-reflection-maintaining interface.

According to a further feature of an embodiment of the present invention, a normal to the PBS forms an angle of less than 45 degrees with a normal to the internal-reflection-maintaining interface.

According to a further feature of an embodiment of the present invention, the PBS is incorporated into a prism that is optically bonded to the lightguide, and wherein the lightguide has a thickness dimension in a direction perpendicular to the first pair of major surfaces, the PBS occupying a thickness of the prism in the direction perpendicular to the first pair of major surfaces that is greater than the thickness dimension of the lightguide.

According to a further feature of an embodiment of the present invention, the lightguide further comprises a second pair of mutually-parallel major surfaces, perpendicular to the first pair of major surfaces, the first and second pairs of major surfaces supporting propagation of image light by four-fold internal reflection at the first and second pairs of major surfaces.

According to a further feature of an embodiment of the present invention, a normal to the PBS is non-parallel to both the first and second pairs of major surfaces.

According to a further feature of an embodiment of the present invention, the reflective lens has an optical axis that is non-parallel to both the first and second pairs of major surfaces.

According to a further feature of an embodiment of the present invention, the prism comprises a first surface parallel to or coplanar with one of the first pair of major surfaces and a second surface parallel to or coplanar with one of the second pair of major surfaces, the first surface provided with the internal-reflection-maintaining interface.

According to a further feature of an embodiment of the present invention, the PBS is incorporated into a prism that is optically bonded to the lightguide, and wherein the lightguide has a first thickness dimension in a direction perpendicular to the first pair of major surfaces and a second thickness dimension in a direction perpendicular to the second pair of major surfaces, the PBS occupying a thickness of the prism in the direction perpendicular to the first pair of major surfaces that is greater than the first thickness dimension and a thickness of the prism in the direction perpendicular to the second pair of major surfaces that is greater than the second thickness dimension.

According to a further feature of an embodiment of the present invention, the internal-reflection-maintaining interface is implemented as a layer of material having a refractive index lower than a refractive index of the lightguide.

According to a further feature of an embodiment of the present invention, the internal-reflection-maintaining interface incorporates an air gap.

According to a further feature of an embodiment of the present invention, the internal-reflection-maintaining interface is implemented as a multi-layer dielectric coating configured to be substantially transparent for visible light within a first range of incident angles and to be reflective for visible light within a second range of incident angles, the second range being at higher angles to a normal to the interface than the first range.

According to a further feature of an embodiment of the present invention, there is also provided a light-absorbing boundary deployed along at least two edges of the PBS to define an optical aperture of the collimated image.

According to a further feature of an embodiment of the present invention, the PBS is incorporated into a prism that is optically bonded to the lightguide, the image generator comprising an illumination arrangement for directing illumination from an illumination aperture through the prism to the image plane, wherein a first part of the illumination undergoes an odd number of reflections from the illumination aperture to the image plane and a second part of the illumination undergoes an even number of reflections from the illumination aperture to the image plane.

According to a further feature of an embodiment of the present invention, the lightguide lies between the image plane and the reflective lens.

According to a further feature of an embodiment of the present invention, the PBS lies between the first pair of major surfaces of the lightguide.

According to a further feature of an embodiment of the present invention, the collimating optical arrangement is a polarizing catadioptric collimating arrangement in which the reflective lens has a partially-reflecting surface, and wherein the image plane is located so as to deliver image light by transmission through the partially-reflecting surface, the image light being reflected back towards the partially-reflecting surface.

There is also provided according to the teachings of an embodiment of the present invention, a display comprising: (a) a lightguide formed from transparent material having a first major surface and a second major surface parallel to the first major surface, the lightguide supporting propagation of image light by internal reflection at the first and second major surfaces; (b) an image generator for generating an image at an image plane; and (c) a polarizing catadioptric collimating and coupling-in arrangement comprising: (i) a non-planar partially-reflecting first reflector associated with the first major surface of the lightguide, (ii) a second reflector associated with the second major surface of the lightguide, in facing relation to the partial reflector, and (iii) a planar third reflector obliquely angled to the major surfaces, wherein one of the second and third reflectors is a full reflector, and another of the second and third reflectors is a polarization-selective reflector interposed between the full reflector and the first reflector, the polarizing catadioptric collimating and coupling-in arrangement further comprising at least one phase plate interposed between the polarization-selective reflector and the first reflector such that image light from the image plane is partially transmitted through the partially-reflecting first reflector which serves as a refractive lens, traverses at least part of a thickness of the lightguide and is reflected at the second reflector, is partially reflected at the partially-reflecting first reflector which serves as a reflective lens, and is reflected by the third reflector so as to be coupled in to propagate by internal reflection within the lightguide.

According to a further feature of an embodiment of the present invention, the second reflector is the full reflector, and wherein the third reflector is the polarization-selective reflector, deployed within the thickness of the lightguide.

According to a further feature of an embodiment of the present invention, the second reflector is the polarization-selective reflector, and wherein the third reflector is the full reflector, associated with a prism external to the thickness of the lightguide.

According to a further feature of an embodiment of the present invention, the second reflector is a planar reflector.

There is also provided according to the teachings of an embodiment of the present invention, a projector for a display, the projector comprising: (a) a reflective spatial light modulator (SLM) for modulating the polarization of light reflected from an image plane; (b) an illumination source outputting illumination from an illumination aperture; (c) a collimating optical arrangement including at least one lens; and (d) a prism containing a polarizing beam splitter (PBS), wherein the PBS is deployed to reflect illumination from the illumination aperture towards the SLM and to allow light corresponding to an image reflected from the SLM to pass through the PBS to reach the collimating optical arrangement, and wherein a surface of the prism adjacent to the SLM is provided with an internal-reflection-maintaining interface, and wherein part of the illumination from the illumination aperture is reflected at the interface and then from the PBS before being incident on the SLM such that a first part of the illumination undergoes an odd number of reflections from the illumination aperture to the SLM and a second part of the illumination undergoes an even number of reflections from the illumination aperture to the SLM.

### BRIEF DESCRIPTION OF THE DRAWINGS

The invention is herein described, by way of example only, with reference to the accompanying drawings, wherein:

FIG. 1A is a schematic side view of a lightguide-integrated projector for injecting images into a lightguide of an augmented reality display, constructed and operative according to an embodiment of the present invention, employing a polarizing catadioptric collimating arrangement;

FIG. 1B is a schematic side view of a lightguide-integrated projector for injecting images into a lightguide of an augmented reality display, constructed and operative according to an embodiment of the present invention, employing an alternative polarizing catadioptric collimating arrangement;

FIG. 1C is a schematic side view similar to FIG. 1B showing an implementation that employs a reflective spatial light modulator for image generation;

FIG. 1D is a schematic side view similar to FIG. 1A illustrating the use of multiple lightguide-integrated projectors for injecting images of different colors;

FIGS. 2A-2C are schematic side views of a lightguide-integrated projector for injecting images into a lightguide of an augmented reality display, constructed and operative according to embodiments of the present invention, employing a reflective collimating arrangement and a polarizing beam splitter located, respectively, within the lightguide, in a prism adjacent to the lightguide, and in a prism above the lightguide;

FIG. 2D is a schematic side view similar to FIG. 2C illustrating the use of multiple lightguide-integrated projectors for injecting images of different colors;

FIG. 2E is a schematic side view illustrating an alternative construction for the lightguide-integrated projector of FIG. 2B;

FIG. 3A is an isometric view of a lightguide arrangement corresponding to FIG. 2B implemented with a rectangular lightguide;

FIG. 3B is a view similar to FIG. 3A illustrating deployment of a polarizing beam splitter at an oblique angle to both axes of the rectangular lightguide;

FIG. 3C is a view similar to FIG. 3B where the polarizing beam splitter is replaced by a reflector;

FIGS. 3D and 3E are similar to FIGS. 3B and 3C, respectively, where the polarizing beam splitter or the reflector are reduced in size to fit within the dimensions of the rectangular lightguide;

FIG. 3F is a view similar to FIG. 3A illustrating additional components of the projector deployed to generate an inclined optical axis;

FIG. 4A is a side view of a lightguide-integrated projector generally similar to FIG. 2B illustrating an arrangement for flood-illumination of a reflective spatial light modulator;

FIG. 4B is a side view similar to FIG. 4A illustrating an arrangement for scanned laser-illumination of a reflective spatial light modulator;

FIGS. 5A and 5B are a side view and an isometric view, respectively, of a lightguide-integrated projector similar to FIG. 4A illustrating various arrangements for spatial filtering of the projected image;

FIGS. 6A and 6B are side views similar to FIGS. 2B and 2C, respectively, illustrating options for polarization control to achieve plane polarization of an image entering the lightguide;

FIGS. 6C and 6D are side views similar to FIGS. 2B and 2C, respectively, illustrating options for polarization control to achieve circular polarization of an image entering the lightguide;

FIGS. 7A and 7B are a side view and a top view, respectively, of a further implementation of a lightguide-integrated projector for injecting images into a lightguide of an augmented reality display, constructed and operative according to an embodiment of the present invention, employing a rectangular lightguide, and further illustrating illumination light paths undergoing total internal reflection;

FIG. 7C is a view similar to FIG. 7A illustrating ray paths corresponding to an additionally image point not shown in FIG. 7A;

FIG. 7D is an isometric view of the lightguide-integrated projector of FIG. 7A;

FIGS. 8A and 8B are schematic side views illustrating design considerations in an illumination arrangement for a reflective spatial light modulator; and

FIG. 8C is a schematic side view illustrating a preferred implementation of an illumination arrangement for a reflective spatial light modulator according to a further aspect of the present invention.

### DESCRIPTION OF THE PREFERRED EMBODIMENTS

The present invention is a lightguide-integrated image projector for injecting images into a lightguide of an augmented reality display.

The principles and operation of displays according to the present invention may be better understood with reference to the drawings and the accompanying description.

By way of introduction, the present invention provides a number of different configurations in which an image projector is integrated with a lightguide in a manner that brings at least part of the collimating optics particularly close to an aperture of the lightguide, thereby providing particularly compact projector configurations. In some cases, a reflective or reflective-refractive (catadioptric) lens is deployed on a surface of the lightguide itself, while in other cases, the lens is deployed on a prism surface which is parallel to, or coplanar with, a surface of the lightguide. In some cases, a polarizing beam splitter (PBS) deflects light reflected from the collimating lens so as to directly couple collimated image light into the lightguide so as to propagate within the lightguide. In some cases, the collimating lens is associated with the surface of the lightguide or of the prism via an internal-reflection-maintaining interface, such that at least part of the image light coupled in to the lightguide is reflected at the internal-reflection-maintaining interface. Examples of each of these features will be illustrated below.

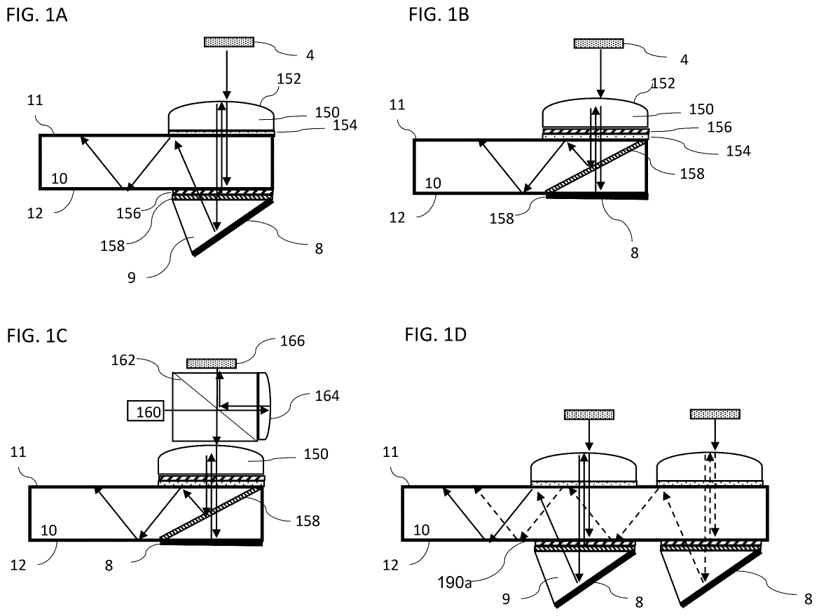

Referring now to the drawings, FIGS. 1A-1D illustrate schematically a number of lightguide-integrated projectors employing polarizing catadioptric collimating optics associated with a major surface of the lightguide, for use in a display.

Specifically, these examples show a lightguide 10 formed from transparent material having a first major surface 11 and a second major surface 12 that are parallel, supporting propagation of image light within the lightguide by internal reflection at major surfaces 11 and 12. The continuation of the lightguide and the coupling-out arrangement are omitted for simplicity of presentation.

An image generator generates an image at an image plane, which may be an active-matrix image generator 4, a reflective or transmissive spatial light modulator (SLM) such as an LCOS chip 166, a digital light processor, or any other desired image generator.

The device further includes a polarizing catadioptric collimating and coupling-in arrangement that includes:
1. a lens 150, having a non-planar surface which provides a partially-reflecting first reflector 152, the base of the lens being associated with the first major surface 11 of the lightguide 10;
2. a second reflector, which is typically but not necessarily planar, associated with the second major surface 12 of the lightguide 10, in facing relation to the first reflector 152; and
3. a planar third reflector obliquely angled to the major surfaces.

One of the second and third reflectors is a full reflector, and the other of the second and third reflectors is a polarization-selective reflector interposed between the full reflector and the first reflector. At least one phase plate 156 is interposed between the polarization-selective reflector and the first reflector such that image light from the image plane is partially transmitted through the partially-reflecting first reflector 152 which serves as a refractive lens, traverses at least part of a thickness of the lightguide 10, is reflected at the second reflector, is partially reflected at the partially-reflecting first reflector 152 which serves as a reflective lens, and is reflected by the third reflector so as to be coupled in to propagate by internal reflection within the lightguide 10.

In the cases of FIGS. 1A and 1D, the second reflector is the polarization-selective reflector 158, and the third reflector is the full reflector 8, associated with a prism 9 external to the thickness of lightguide 10. In the cases of FIGS. 16B and 16C, the second reflector is the full reflector 8, and the third reflector is the polarization-selective reflector 158. In the case illustrated here, the polarization-selective reflector is deployed within the thickness of the lightguide. It is also possible to implement the latter cases with full reflector 8 on a plane external and parallel to the plane of surface 12, in which case polarization-selective reflector 158 can also extend outside the thickness of the lightguide, so long as it does not extend beyond the plane of the full reflector.

In more detail, in FIG. 1A, image source 4 (a micro-LED or OLED, for example) transmits light onto lens 150. The light passes through partial transmitting curved surface (first partial reflector) 152 and through an internal-reflection-maintaining interface 154, such as a layer of low refractive index material or and air-gap, into lightguide 10. After crossing through the lightguide, the beam passes through waveplate 156 (which may be alternatively located above interface 154) to be reflected by polarizer-reflector 158. The reflected beam passes through interface 154 to be partially back-reflected by first reflector 152. The reflected beam passes once more through the lightguide 10 and, after a second pass through waveplate 156, it has an orthogonal polarization so as to pass through polarizer-reflector 158 and to be reflected by reflector 8. The beam maintains its polarization, therefore passing through polarizer-reflector 158 to be guided by lightguide 10. The part of the beam which impinges on interface 154 undergoes total internal reflection.

FIG. 1B shows a more compact architecture where polarizer-reflector 158, also referred to as a polarizing beam splitter (PBS), is positioned slanted within lightguide 10. The beam entering the lightguide is linearly polarized (orthogonal to the beam entering in FIG. 1A) and therefore passes the PBS 158 to be reflected from reflector 8. The beam passes through PBS 158, interface 154 and waveplate 156 to be partially back-reflected by first reflector 152. After a second pass through waveplate 156, the beam is orthogonally polarized and will therefore be reflected by PBS 158 so as to be coupled-in and guided within lightguide 10.

FIG. 1C shows a variant implementation similar to FIG. 1B but employing an LCOS image projector. Similar variants may also be implemented based on FIG. 1A. The light from a source 160 (which may for example be LED illumination or a scanned laser beam) is reflected by a focusing reflective lens 164 onto PBS surface 162 to illuminate the LCOS matrix 166. The light modulated by the LCOS passes through PBS 162 and enters lens 150, then following the same sequence as described above in the context of FIG. 1B.

Configurations such as that of FIG. 1A can be combined in sequence along a lightguide 10 with a dichroic coating adjacent to waveplate 156, as shown in FIG. 1D, where 190a represents the dichroic surface. This allows sequential coupling-in of different color images along the lightguide.

FIGS. 1B and 1C exemplify a particularly compact coupling-in arrangement where a PBS deployed close to a reflective lens is used to couple in the collimated image to the lightguide, and an internal-reflection-maintaining interface allows the image light to be guided at the interface beneath the reflective lens. This approach is not limited to the catadioptric optical arrangements of these examples, and will be illustrated below with reference to alternative optical arrangements employing reflective-only lenses.

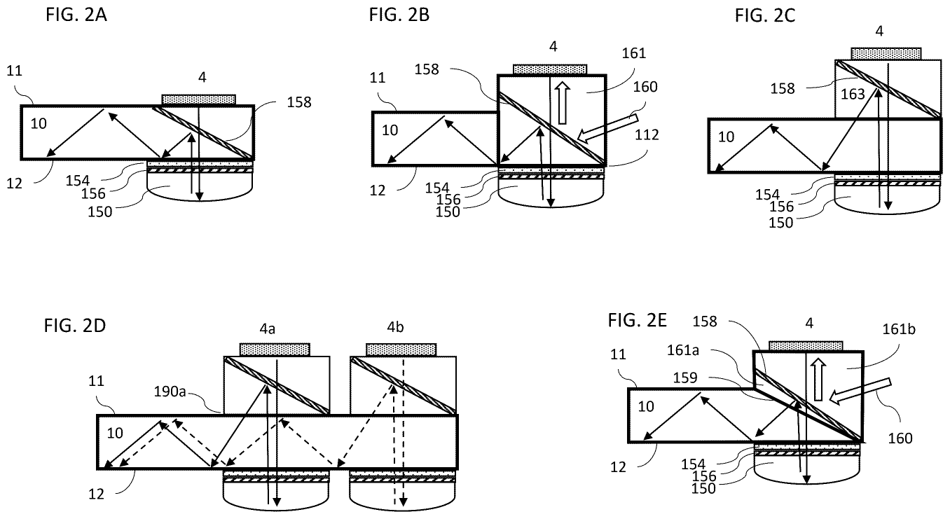

Turning now to FIGS. 2A-2E, these illustrate part of a display including a lightguide 10 formed from transparent material having a first pair of mutually-parallel major surfaces 11, 12 for supporting propagation of image light by internal reflection, and an image generator for generating an image at an image plane 4. The device also includes a collimating optical arrangement, including a reflective lens 150 and an associated quarter-wave phase plate 156, and a polarizing beam splitter (PBS) 158. Reflective lens 150 is associated with one of the major surfaces 12, or with a surface 112 of a prism 161, where surface 112 is parallel to, or coplanar with, major surface 12, via an internal-reflection-maintaining interface 154, which maintains or simulates total internal reflection (TIR) conditions. The PBS 158 is deployed so that image light from the image plane 4 passes through the PBS 158 to impinge on the reflective lens 150, is collimated by the reflective lens, and is then reflected by the PBS 158 so as to be coupled in to propagate within lightguide 10 by internal reflection at major surfaces 11 and 12. At least part of the image light is reflected at the internal-reflection-maintaining interface 154.

In more detail, FIG. 2A illustrates image source 4 (for example, OLED, Micro LED or LCOS) deployed to transmit image light through the major surface 11 of lightguide 10, through PBS 158 (light polarized to transmit, preferably P) through interface 154, through quarter-wave-plate 156 and onto reflective lens 150. In this case, the external face of lens 150 is highly reflective (preferably at least 95%, and typically close to 100%), acting as a reflective collimating lens. The reflected light passes once again through quarter-wave plate 156 and interface 154. Now that the polarization is orthogonal (preferably S) to the polarization initial introduced, it is reflected by PBS 158 to a range of angles that are guided by lightguide 10. The internal-reflection-maintaining interface 154 ensures internal reflection of the angled reflected light, thereby achieving efficient coupling in. The angle of the PBS 158 is chosen according to the desire range of angles at which the image light should propagate within the lightguide. The PBS typically forms an angle of less than 45 degrees with the major surfaces and the internal-reflection-maintaining interface, and in certain preferred implementations, may be at an angle of between about 25 degrees and 40 degrees to the major surfaces/interface. Where reference is made herein to an angle between two planes or surfaces, this may be defined as the angle between a normal to the first surface and a normal to the second surface.

The example of FIG. 2A is particularly compact, since lightguide 10 lies between image plane 4 and reflective lens 150, and additionally because PBS 158 lies between major surfaces 11 and 12, being fully contained within the thickness of lightguide 10. This compactness may come at a cost of some lack of uniformity, due to incomplete “filling” of the thickness of the lightguide with all fields of the image. This can be remedied by use of uniformity enhancing arrangements, such as a “mixer” partial reflector deployed within the lightguide parallel to the major surfaces, and most preferably a 50% reflector located at a center plane of the lightguide.

FIG. 2B depicts an architecture that illuminates the lightguide more uniformly. For this, PBS 158 extends beyond the faces of lightguide 10. Structurally, PBS 158 is here incorporated into a prism 161 that is optically bonded to lightguide 10. The PBS 158 occupies a thickness of the prism in a direction perpendicular to major surfaces 11, 12 that is greater than the thickness dimension of lightguide 10 in a direction perpendicular to the major surfaces 11, 12.

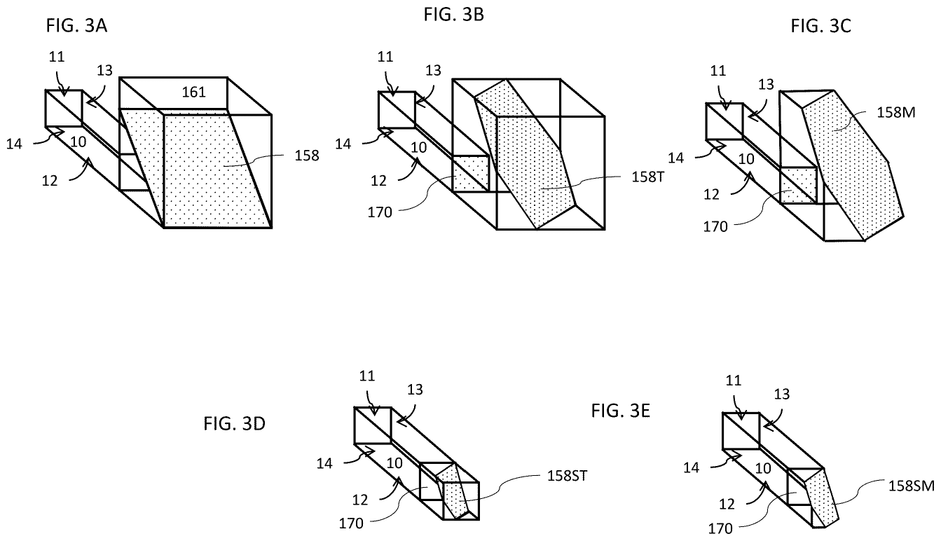

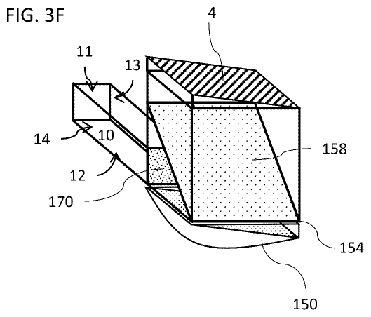

If the lightguide 10 is a rectangular cross-section lightguide guiding light by reflection at two orthogonal sets of major surfaces, PBS 158 should extend beyond both dimensions of the lightguide, as will be illustrated below with reference to FIGS. 3A-3C and 3F.

FIG. 2C shows a simplified configuration where lightguide 10 is included in the path of the projector optics. Here, PBS prism 163 is placed on top of lightguide 10 and the reflecting lens 150 and associated components are implemented as in FIG. 2A. The focal distance in such a system is longer than for FIG. 2B, but integration of such a system is simpler. This configuration can achieve uniform lightguide illumination by choosing the length of PBS 158 appropriately.

FIG. 2D shows a cascading configuration based on the structure of FIG. 2C where the image sources 4a and 4b are of different wavelengths (colors) and surface 190a is a dichroic coating.

FIG. 2E shows another implementation for integrating a PBS prism onto lightguide 10. Here, the lightguide 10 is polished to generate plane 159. This plane serves as the reference base for a PBS prism 161a. The prism is placed on top to generate the plane at which PBS 158 is deployed, and another prism 161b is added to support the image generator 4. The resulting structure is optically equivalent to the structure of FIG. 2B.

Each of the above configurations can be implemented using an LCOS image generator, where illumination is injected from an illumination source at the side, as illustrated schematically in FIGS. 2B and 2E by thick arrow 160, or in more detail with reference to FIG. 1C.

As mentioned earlier, aspects of the present invention may be implemented for injecting image light into a “rectangular lightguide”, i.e., where the lightguide has a first pair of mutually-parallel major surfaces 11, 12 and a second pair of mutually-parallel major surfaces 13, 14, (see FIG. 3A) perpendicular to the first pair of major surfaces. Such a lightguide supports propagation of image light by four-fold internal reflection at the first and second pairs of major surfaces. Such a rectangular lightguide is typically used as a first dimension of optical aperture expansion in combination with a slab-type lightguide (with only one pair of major surfaces) which delivers the image light to the user's eye. Suitable configurations for combining a rectangular lightguide with a second lightguide are disclosed in the Applicant's patent publications U.S. Pat. No. 10,133,070 B2 and WO 2023/131959 A1.

Image light introduced into a rectangular lightguide should be injected in directions inclined relative to both axes of the lightguide. This can be achieved by using a “twisted” inclination of the PBS, where a normal to the PBS is non-parallel to both pairs of major surfaces and/or by inclining the optical elements so that the reflective lens has an optical axis that is non-parallel to both pairs of major surfaces. These options are exemplified with reference to FIGS. 3A-3F. The rectangular lightguide implementations are relevant to each of the variants illustrated in FIGS. 2A-2E.

FIG. 3A shows schematically an isometric view of FIG. 2B. Here the surface 158 is within prism 161. This configuration is suitable for a case in which lightguide 10 is a slab-type lightguide with only two reflecting external surfaces (up and down). If used with a rectangular lightguide, it can be seen that the normal to the PBS is parallel to second pair of major surfaces 13, 14. Inclination of the image light can be implemented using a suitable inclination of the optical elements (not shown), as will be exemplified in FIG. 3F.

FIG. 3B shows coupling into a rectangular lightguide 10. Here the PBS surface 158T is tilted in both dimensions, which facilitates a correct inclination of the reflected beam for coupling in to propagate by fourfold reflection and to fully fill the lightguide 10 with all four images. FIG. 3C shows PBS surface 158M as an external reflector, for an implementation analogous to that of FIG. 1A, i.e., where the image light is injected from below (in the orientation illustrated here).

In the implementations of FIGS. 3A-3C, the PBS is incorporated into a prism 161 that is optically bonded to the lightguide, and the PBS occupies a thickness of the prism that is greater than the thickness of the lightguide in both lateral dimensions. This allows the image light to fill the lightguide with all of the fourfold images. Additionally, in order to couple in light reflected from the PBS to provide all of the four-fold images at the entrance to the lightguide, prism 161 is provided with two surfaces which are parallel to, and most preferably coplanar with, two adjacent surfaces of the rectangular lightguide, serving as a continuation of those surfaces for the purpose of the coupling in.

A more compact prism size can be achieved by implementing a PBS as shown in FIGS. 3D and 3E that are equivalent to 2A and 1A, respectively. These configurations will not fill the lightguide with the image and all of its reflections, but subsequent filling can be achieved using mixer elements, as mentioned above.

FIG. 3F elaborates on FIG. 3A showing PBS 158 that is perpendicular to one of the pairs of major surfaces of a rectangular lightguide. To achieve the required range of inclination angles for injection of the image light into the rectangular lightguide, the plane of image generator 4 and the plane of collimating lens 150 are tilted, thereby generating a tilted principle optical axis as required for injecting into lightguide entrance 170.

In all of the above examples of FIGS. 3A-3F, where the optical axis and/or the PBS have inclination in two directions relative to the lightguide and prism axes, the required polarization orientation is dictated according to how the propagating beams meet the PBS and does not correspond to the axes of the lightguide. In certain cases, polarization rotation is needed before the light enters the lightguide. A waveplate or polarizer can be introduced at the entrance 170 to the lightguide for this purpose.

As mentioned above, all of the implementations described herein may be implemented with any suitable image generator. Structurally, if the image generator is a micro-LED array deployed at image plane 4, no additional structure may be required to complete the optical arrangement. The supporting electronic components (power supply, data storage and processing components and controllers etc.) that are required for operating all implementations are well known to those skilled in the art and are not shown here.

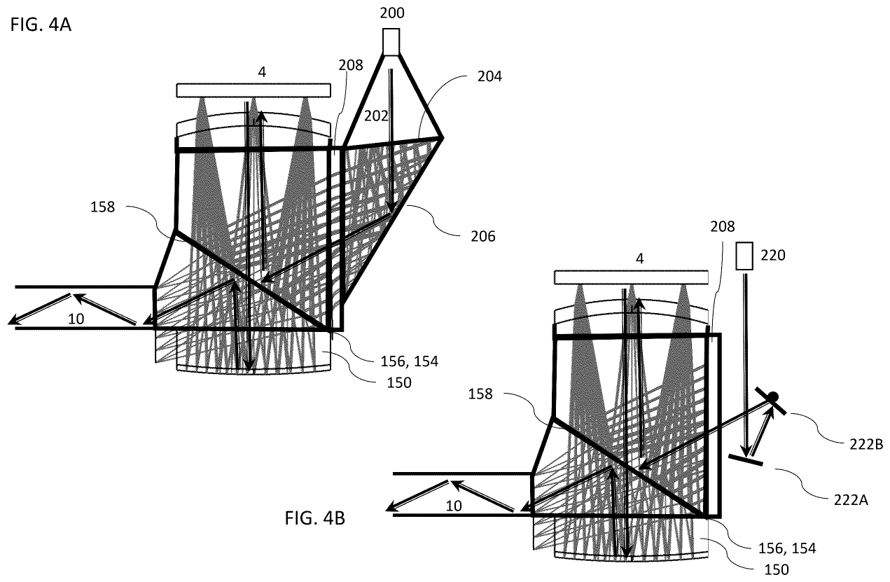

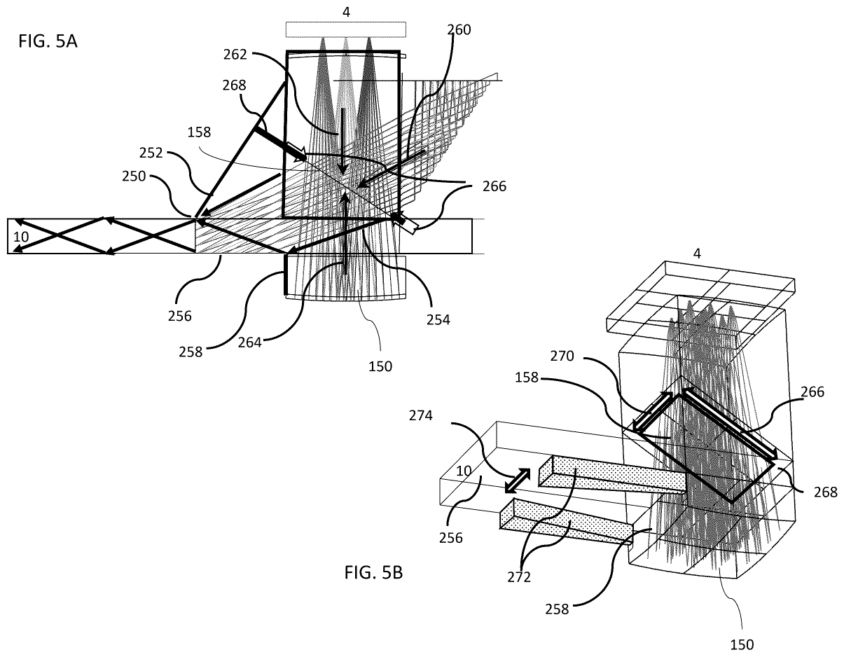

If the image generator is a reflective spatial light modulator (SLM), such as a Liquid Crystal on Silicon (LCOS) chip, additional optical components are needed to direct illumination, such as from LEDs or lasers, to illuminate the LCOS at image plane 4. By way of one example, FIG. 4A illustrates LED 200 illuminating an LCOS at plane 4. The light from the LED is expanded in a light-pipe 202 and, if needed, a diffuser 204 is introduced at the end of the light-pipe. Reflector 206 reflects the light onto the PBS. If needed, further beam collimation is performed by a Fresnel lens 208 placed just before the PBS.

In FIG. 4B, a laser 220 illuminates a set of scanning mirrors 222A and 222B (one or both driven in a scanning motion by suitable drive components, not shown) through Fresnel lens 208 and onto the PBS 158 and LCOS 4.

A further aspect of the present invention relates to spatial filtering of image light injected into the lightguide. Scattered light within the projector may reduce contrast of the image and a large beam divergence may reduce resolution due to aberrations. A spatial filter (aperture) may be implemented in order to block this scattered light and limit the beam numerical-aperture (divergence) to a nominal value.

FIGS. 5A and 5B show various spatial filtering configurations which may be implemented in any of the implementations described herein. Any combination of filters is also possible. By way of one non-limiting example, the configurations illustrated here are exemplified in the context of the design described above with reference to FIG. 2C.

FIG. 5A shows that the entrance to lightguide 10 includes an edge 250 that performs vertical spatial filtering of the light entering the lightguide. Preferably, prism surface 252 is provided with an absorbent coating to prevent scattering of light hitting that surface, thereby enhancing the vertical filtering effect.

In this configuration, beam 254 is the lowest beam reflected from surface 256 into the lightguide. This reflection is close to the edge 258 of reflective lens 150. By making surface 258 an absorber, efficient trimming of excess beams is achieved.

In a preferred embodiment, the three sets of beams impinging on PBS 158 (illumination 260, diverging 262 and collimated 264) impinge on the same overlapping area of 158 as shown in FIG. 5A. Thus, according to a further feature of the present invention, an efficient spatial filter (aperture) can be implemented on this PBS plane. Arrows 266 show the opening of this spatial filter while an absorber 268 is placed around it. FIG. 5B is an isometric view showing that the spatial filter on the PBS plane has also lateral width 270 where the absorber 268 is located around the opening of the PBS 158. FIG. 5B omits the additional part of the prism providing 252 and the illumination arrangement optics, for clarity and simplicity of presentation.

FIG. 5B also illustrates a further option for spatial filtering in an in-plane direction of the lightguide, which may be used in addition to, or instead of, the aperture in the plane of the PBS. A lateral aperture 274 may be generated at location 250 by eliminating TIR associated with beams diverging outside this aperture. Elements 272 (shown only in FIG. 5B and omitted from FIG. 5A for clarity) are attached to surface 256 thereby spatially-selectively eliminating TIR on this plane. Beams within lightguide 10 impinging on these elements 272 will be coupled out and absorbed. The shape of elements 272 enables guidance and transmittance of the image beams that will pass through lateral aperture 274 and vertical aperture 250. Elements 272 may be located on the other side (top) of lightguide 10, or on both sides. The shape of elements 272 illustrated here is one non-limiting example, and shorter or longer shapes element, or elements of different shapes, may be used. Furthermore, in certain cases, such as where independent projectors are deployed for injecting images of different colors, elements may be configured to selectively absorb only one color. The shape can also extent beyond aperture 274 while providing additional image beams guidance.

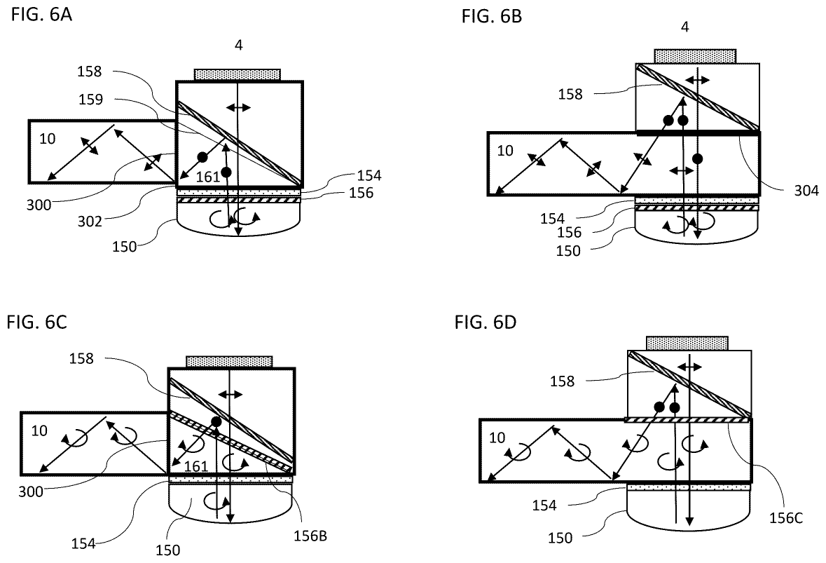

FIGS. 6A-6D describe options for polarization management in the configurations described in FIGS. 2A-2E. By way of example, the configuration of FIG. 2B is the basis for FIGS. 6A and 6C, while FIG. 2C is the basis for FIGS. 6B and 6D. In this description, the polarization orientation is defined relative to PBS 158, where double-headed arrows crossing the beams represent P polarization and black dots denote S polarization. Circular polarization is represented as curved arrows where for clarity the same direction is shown for reflected circular polarization.

The examples shown here illustrate the normal operation of PBS 158, which is optimally to reflect S polarization and transmit P polarization. It will be appreciated however that this is only by way of example, and that the implementations are not limited to this option, since some polarizers can operate in other orientations (for example, a wire-grid polarizer).

In FIG. 6A, P-pol light from LCOS 4 passes through PBS 158 and subsequently passes through quarter-wave-retarder (QW) 156, thereby generating circular polarization. (It should be noted that the terms “retarder”, “phase plate” and “waveplate” are used herein interchangeably.) Lens 150 reflects the circular polarization to pass once more through QW 156, thereby generating S-pol that reflects from PBS 158. If the requirement is to have S-pol injected into lightguide 10, then no further element is needed. However, if P-Pol is required, then a half-wave-retarder (HW) is implemented on surface 300. If unpolarized light is needed, a birefringent depolarizer may be introduced at this plane.

Introducing an element at plane 300 may cause scattering at the interface. To ameliorate this issue, it is possible to implement prism 161 slightly enlarged and shifted by a step 302 so that light scattered from the edge will not enter lightguide 10. The surface of prism 161 formed at internal-reflection-maintaining interface 154 must still be parallel to the surface of the lightguide, since it takes part in coupling-in of the image light reflected by PBS 158.

The half-wave retarder may alternatively be implemented on plane 159 or adjacent to (and below) PBS 158. In such a case, the polarization progress is equivalent to that described below for FIG. 6B.

In FIG. 6B, the half-wave phase plate is placed on surface 304, that is part of one of the major lightguide surfaces. The P-pol that passes through PBS 158 is rotated to S-pol after 304. The beam polarization is rotated to P-pol after reflection from 150 and passing twice through QW 154. After passing once more through 304, the beam is S-pol, and is therefore reflected by PBS 158. The third pass through 304 rotates the beam to be P-pol as it enters the lightguide 10, as required. In this configuration, S-pol injection into lightguide 10 is achieved simply by omitting the HW from surface 304.

FIGS. 6C and 6D describe configurations for injecting circularly polarized light into lightguide 10. In FIG. 6C, QW 156B is placed at some spacing from, or adjacent to, PBS 158 (and not next to interface 154). P-pol diverging image light passing through PBS 158 and QW 156B is circularly polarized. After reflecting from 150 and passing once more through QW 156B, it is S-pol, and is reflected from PBS 158. This reflected light now passes a third time through QW 156B to generate circularly polarized light that is injected into lightguide 10.

Alternatively, a QW retarder may be implemented in plane 300 of FIG. 6A to generate circular polarization in lightguide 10. In FIG. 6D, the QW is placed on plane 156C (instead of adjacent to the PBS), but achieves analogous polarization management to FIG. 6C.

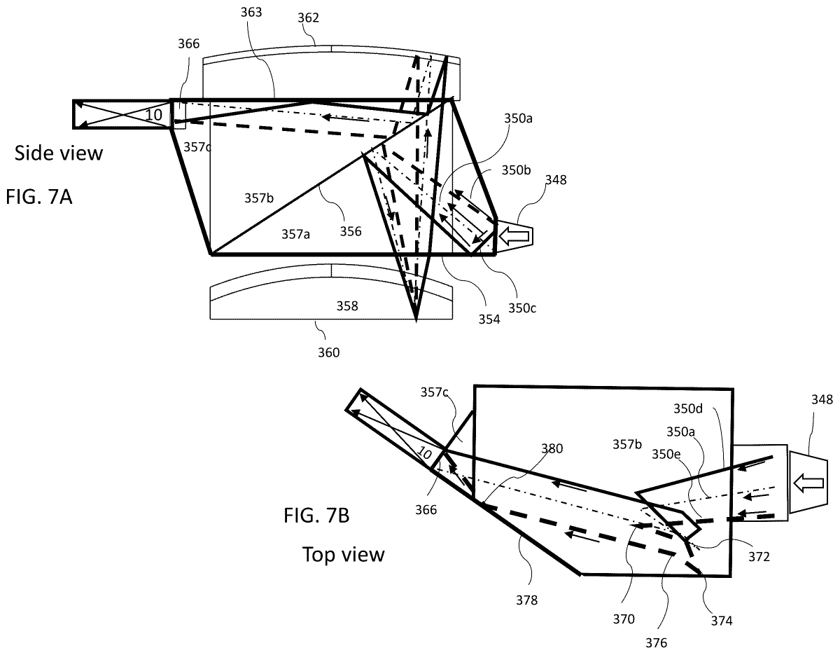

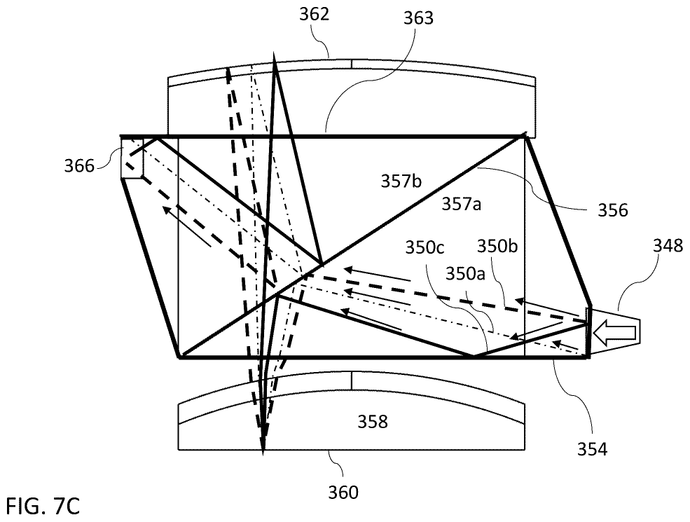

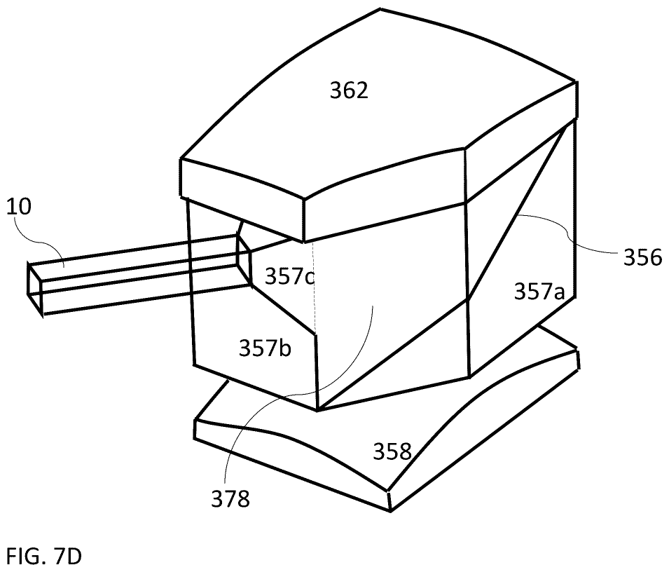

As described above with reference to FIGS. 3A-3F, coupling an image into a rectangular lightguide requires that the optical axis of the projector be tilted in two axes relative to lightguide axes, thereby initiating fourfold image propagation within the lightguide. FIGS. 7A-7D illustrate a further particularly preferred implementation as an alternative to the configuration of FIG. 3F. In this implementation, the bottom surface of the lens (150 in FIG. 3F) is immediately adjacent to the TIR interface (154 in FIG. 3F), thereby simplifying integration.

The configuration in FIGS. 7A-7D can be used for a light-emitting image matrix such as a micro-LED array, but can also be implemented using an illuminated spatial light modulator (SLM), such as an LCOS chip. The example shown herein is for an illuminated LCOS where the illumination section itself incorporates partial TIR according to a further aspect of the present invention, as will be described further below. Due to this combination of features, this projector employs a prism which includes three distinct surfaces which provide TIR properties.

FIG. 7A shows a side view and FIG. 7B shows a top view of beam propagation associated with one point in the projected field. Polarization elements are not elaborated upon in this description, but will be self-evident to a person ordinarily skilled in the art.

As seen in FIG. 7A, light from source 348 is projected into a prism 357a that, together with a prism 357b, includes a PBS 356. The light source may be an arrangement of one or more LEDs, or may be the exit aperture of a lightpipe which homogenizes illumination from one or more LED light sources. The central beam 350a (shown as dot-dashed) propagates into PBS 356 and is reflected down through surface 354 onto a lens 358 to be reflected by SLM (for example, LCOS) 360. The reflected beam propagates through lens 358, surface 354, PBS 356, and a surface 363, to be reflected by reflecting lens 362. The reflected beam passes through surface 363 to be reflected by PBS 356, through prism 357b and prism extension 357c onto exit aperture 366 that is the entrance to lightguide 10. Two other beams are shown associated with same image point. Beam 350b (shown as dashed) also propagates directly through prism 357a onto PBS 356, while beam 350c (solid line) is first reflected by surface 354 before impinging on PBS 356. Thus, part of the illumination undergoes an odd number of reflections between the illumination aperture and the SLM image plane, while another part of the illumination undergoes an even number of reflections. These odd and even reflections are part of the optical path which images source 348 onto exit aperture 366, as further described below.

As described in previous configurations, some of the beams (beam 350c in this case) is reflected by TIR from surface 363 onto exit aperture 366, thereby facilitating filling of the lightguide aperture. There is no correlation between the rays which undergo TIR at surface 354 and those which undergo TIR at surface 363.

FIG. 7B shows central ray 350a and other rays (350d, solid, and 350e, dashed, both following paths similar to ray 350a). Ray 350e originated from illumination aperture 348, impinging on PBS 356 (from top shown as ray 370) reflecting from LCOS 360 (ray 372), reflecting from top reflective lens 362 (ray 374), from PBS 356 (ray 376) and from side surface 378 (this surface not visible in the side view FIG. 7A) into prism extension 357c and via exit aperture 366 into lightguide 10.

The prism configuration provides two surfaces which are parallel to, or coplanar with, the major surfaces of the rectangular lightguide, to take part in coupling in of all four images required for four-fold propagation into the lightguide at exit aperture 366. The extent to which these surfaces need to extend depends on the details of the implementation. In the case illustrated here, surface 378 is provided partially by extension prism 357c and partially by prism section 357b, as seen in FIG. 7B. The other coupling-in surface is provided by interface 363 and its extension over prism 357c, as seen in FIG. 7A. The overall resulting shape of the projector prisms is best seen in FIG. 7D.

For clarity, FIG. 7C shows beam propagation for a different point in the image. Reflections are at different angles but the principle of the optical path is same as shown in FIG. 7A.

Optimal coupling of light from illumination aperture 348 to exit aperture 366 is achieved if exit aperture 366 is imaged to the plane of illuminator aperture 348 and if surface 354 ends at the center of this image. In this case, the vertical size of illumination aperture 348 is effectively doubled by reflection at plane 354, so the illumination source can be half the size of the exit aperture (in this example of a one-to-one imaging ratio). Laterally (as shown in the top view of FIG. 7B), the size of the illumination aperture 348 is equal to twice the width of the image on 366 (as required for uniform illumination/filling of the lightguide).

The configuration illustrated in FIGS. 7A and 7C can also be used to advantage for projecting an image into a slab-type (one-dimensional) lightguide, where the other dimension of the prism allows divergence of the image for the in-plane dimension of the lightguide (i.e., without surface 378).

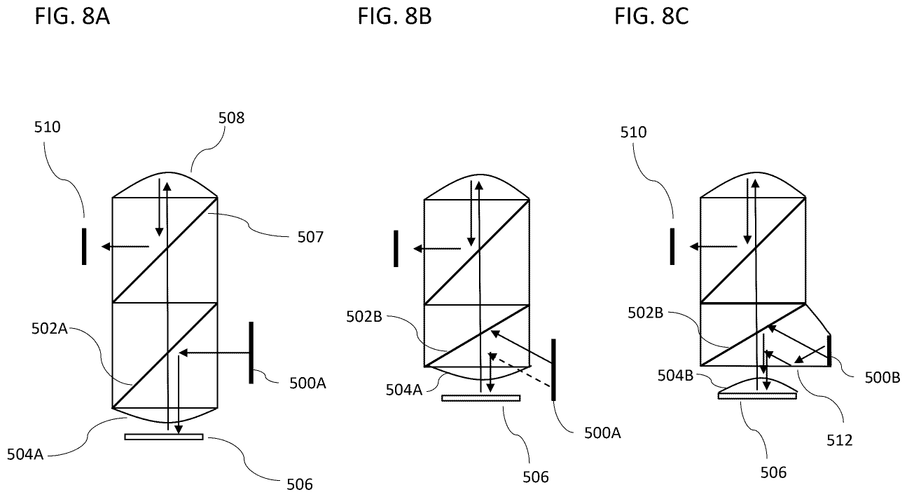

The illumination architecture described in relation to FIGS. 7A-7D is believed to be inventive in its own right, independent of the additional features disclosed above. To clarify the distinctive features of this aspect of the present invention, FIGS. 8A-8C illustrate design considerations for an illumination arrangement for a SLM in the context of an otherwise conventional image projector for a near-eye display, where FIG. 8C corresponds to the preferred implementation of the illumination arrangement.

Thus, according to this aspect of the present invention, a projector for a display includes a reflective spatial light modulator (SLM) 506 for modulating the polarization of light reflected from an image plane, an illumination source outputting illumination from an illumination aperture 500B, a collimating optical arrangement including at least one lens 508, and a prism containing a polarizing beam splitter (PBS) 502B. The PBS 502B is deployed to reflect illumination from the illumination aperture 500B towards the SLM 506 and to allow light corresponding to an image reflected from the SLM to pass through the PBS to reach the collimating optical arrangement 508.

It is a particular feature of this aspect of the present invention that a surface 512 of the prism adjacent to the SLM 506 is provided with an internal-reflection-maintaining interface, and that part of the illumination from illumination aperture 500B is reflected at the interface and then from the PBS before being incident on the SLM. As a result, a first part of the illumination undergoes an odd number of reflections along its path from the illumination aperture 500B to the SLM 506, and a second part of the illumination undergoes an even number of reflections from the illumination aperture 500B to the SLM 506.

FIG. 8A illustrates a simplified architecture of an image projector based on an LCOS image generator using a conventional illumination arrangement, in order to better explain the significance of this aspect of the present invention. An illumination source 500A projects the light onto a first PBS 502A that reflects the light through a field lens 504A onto an LCOS chip 506. The modulated light is reflected to a collimating reflecting lens 508 that reflects the light to a second PBS 507 that reflects collimated image light to an exit aperture 510. For optimal power efficiency, the plane of the source 500A is imaged onto the aperture plane 510.

The PBSs 502A and 507 in this schematic representation could be combined into a single PBS, analogous to the arrangement of FIG. 7A.

FIG. 8B shows an attempt to reduce the size of the illumination part of the projector. Here, the angle of PBS 502B is shallower compared to 502A. However, this geometrical change results in some of the light from the source 500A needing to pass through the Field lens (dashed arrow) in a way that will divert and distort the light.

FIG. 8C illustrates a practical solution according to this aspect of the present invention in which the field lens 504B was moved to be on top of the LCOS 506 and the bottom surface of the prism 512 now serves to perform total internal reflection of part of the light emitted by source 500B. Additionally, in this configuration, the emitter can be smaller in size, since it is imaged twice (once directly and once by reflection at surface 512) onto the output aperture 510.

The field lens 504 may still be implemented on the prism surface, as shown in FIG. 8A, in which case an internal-reflection-maintaining interface must be introduced to preserve TIR at plane 512.

Optionally, a phase element (having continuous profile or Fresnel type, and either refractive or reflective) may be introduced on the surface of emitter 500B to direct the beams to generate uniform illumination of the pupil 510. This phase element my divert beams from non-illuminating orientations (such as along surface 512) to illuminating directions.

Emitter 500B may be the exit aperture of a light-pipe, with or without a diffuser, that may be used to mix the illumination originating from multiple sources.

Throughout this document, wherever reference is made to an “internal-reflection-maintaining interface,” this term is used generically to refer to any and all implementations of an interface which maintains, or simulates, total internal reflection (TIR) properties. Thus, such an interface may be implemented as a layer of material having a refractive index lower than a refractive index of the lightguide, or a structure that incorporates an air gap adjacent to the surface, thereby creating classical conditions for TIR at an interface between a material having a higher refractive index reaching a material (or air) with a lower refractive index. Alternatively, the internal-reflection-maintaining interface may be implemented as a multi-layer dielectric coating configured to be substantially transparent for visible light within a first range of incident angles and to be reflective for visible light within a second range of incident angles, the second range being at higher angles to a normal to the interface than the first range, thereby mimicking TIR properties.

It will be appreciated that the above descriptions are intended only to serve as examples, and that many other embodiments are possible within the scope of the present invention as defined in the appended claims.

What is claimed is:

1. A display comprising:
(a) a lightguide formed from transparent material having a first pair of mutually-parallel major surfaces for supporting propagation of image light by internal reflection at said first pair of major surfaces;
(b) an image generator for generating an image at an image plane;
(c) a collimating optical arrangement including a reflective lens and an associated quarter-wave phase plate; and
(d) a polarizing beam splitter (PBS),
wherein said reflective lens is associated with one of said first pair of major surfaces, or with a surface of a prism parallel to or coplanar with one of said first pair of major surfaces, via an internal-reflection-maintaining interface, and wherein said PBS is deployed so that image light from said image plane passes through said PBS to impinge on said reflective lens, is collimated by said reflective lens, and reflected by said PBS so as to be coupled in to propagate within said lightguide by internal reflection at said first pair of major surfaces, at least part of said image light being reflected at said internal-reflection-maintaining interface,
and wherein at least part of said PBS is incorporated into a prism that is optically bonded to said lightguide, and wherein said lightguide has a thickness dimension in a direction perpendicular to said first pair of major surfaces, said PBS occupying a height dimension in the direction perpendicular to said first pair of major surfaces that is greater than said thickness dimension of said lightguide.

2. The display of claim 1, wherein a normal to said PBS forms an angle of less than 45 degrees with a normal to said internal-reflection-maintaining interface.

3. (canceled)

4. The display of claim 1, wherein said lightguide further comprises a second pair of mutually-parallel major surfaces, perpendicular to said first pair of major surfaces, said first and second pairs of major surfaces supporting propagation of image light by four-fold internal reflection at said first and second pairs of major surfaces.

5. The display of claim 4, wherein a normal to said PBS is non-parallel to both said first and second pairs of major surfaces.

6. The display of claim 4, wherein said reflective lens has an optical axis that is non-parallel to both said first and second pairs of major surfaces.

7. The display of claim 4, wherein said prism comprises a first surface parallel to or coplanar with one of said first pair of major surfaces and a second surface parallel to or coplanar with one of said second pair of major surfaces, said first surface provided with said internal-reflection-maintaining interface.

8. The display of claim 4, wherein said lightguide has a first thickness dimension in a direction perpendicular to said first pair of major surfaces and a second thickness dimension in a direction perpendicular to said second pair of major surfaces, said PBS occupying a thickness of said prism in the direction perpendicular to said first pair of major surfaces that is greater than said first thickness dimension and a thickness of said prism in the direction perpendicular to said second pair of major surfaces that is greater than said second thickness dimension.

9. The display of claim 1, wherein said internal-reflection-maintaining interface is implemented as a layer of material having a refractive index lower than a refractive index of the lightguide.

10. The display of claim 1, wherein said internal-reflection-maintaining interface incorporates an air gap.

11. The display of claim 1, wherein said internal-reflection-maintaining interface is implemented as a multi-layer dielectric coating configured to be substantially transparent for visible light within a first range of incident angles and to be reflective for visible light within a second range of incident angles, said second range being at higher angles to a normal to the interface than said first range.

12. The display of claim 1, further comprising a light-absorbing boundary deployed along at least two edges of said PBS to define an optical aperture of the collimated image.

13. The display of claim 1, wherein said image generator comprises an illumination arrangement for directing illumination from an illumination aperture through said prism to said image plane, wherein a first part of the illumination undergoes an odd number of reflections from said illumination aperture to said image plane and a second part of the illumination undergoes an even number of reflections from said illumination aperture to said image plane.

14. The display of claim 1, wherein said lightguide lies between said image plane and said reflective lens.

15. (canceled)

16. The display of claim 1, wherein said collimating optical arrangement is a polarizing catadioptric collimating arrangement in which said reflective lens has a partially-reflecting surface, and wherein said image plane is located so as to deliver image light by transmission through said partially-reflecting surface, the image light being reflected back towards said partially-reflecting surface.

17. A display comprising:
(a) a lightguide formed from transparent material having a first major surface and a second major surface parallel to said first major surface, said lightguide supporting propagation of image light by internal reflection at said first and second major surfaces;
(b) an image generator for generating an image at an image plane; and
(c) a polarizing catadioptric collimating and coupling-in arrangement comprising:
(i) a non-planar partially-reflecting first reflector associated with said first major surface of said lightguide,
(ii) a second reflector associated with said second major surface of said lightguide, in facing relation to said partial reflector, and
(iii) a planar third reflector obliquely angled to said major surfaces, wherein one of said second and third reflectors is a full reflector, and another of said second and third reflectors is a polarization-selective reflector interposed between said full reflector and said first reflector, said polarizing catadioptric collimating and coupling-in arrangement further comprising at least one phase plate interposed between said polarization-selective reflector and said first reflector such that image light from said image plane is partially transmitted through said partially-reflecting first reflector which serves as a refractive lens, traverses at least part of a thickness of said lightguide and is reflected at said second reflector, is partially reflected at said partially-reflecting first reflector which serves as a reflective lens, and is reflected by said third reflector so as to be coupled in to propagate by internal reflection within said lightguide.

18. The display of claim 17, wherein said second reflector is said full reflector, and wherein said third reflector is said polarization-selective reflector, deployed within the thickness of said lightguide.

19. The display of claim 17, wherein said second reflector is said polarization-selective reflector, and wherein said third reflector is said full reflector, associated with a prism external to the thickness of said lightguide.

20. The display of claim 17, wherein said second reflector is a planar reflector.

21. A projector for a display, the projector comprising:
(a) a reflective spatial light modulator (SLM) for modulating the polarization of light reflected from an image plane;
(b) an illumination source outputting illumination from an illumination aperture;
(c) a collimating optical arrangement including at least one lens; and
(d) a prism containing a polarizing beam splitter (PBS),
wherein said PBS is deployed to reflect illumination from said illumination aperture towards said SLM and to allow light corresponding to an image reflected from said SLM to pass through said PBS to reach said collimating optical arrangement,
and wherein a surface of said prism adjacent to said SLM is provided with an internal-reflection-maintaining interface, and wherein part of the illumination from said illumination aperture is reflected at said interface and then from said PBS before being incident on said SLM such that a first part of the illumination undergoes an odd number of reflections from said illumination aperture to said SLM and a second part of said illumination undergoes an even number of reflections from said illumination aperture to said SLM.
